(19) United States
(12) Patent Application Publication
(10) Pub. No.: US 2022/0278450 A1
(43) Pub. Date: Sep. 1, 2022

(54) Low-Profile Low-Cost Phased-Array Antenna-in-Package

(71) Applicant: Kyocera International Inc., San Diego, CA (US)

(72) Inventor: Kevin Jiang, Monterey Park, CA (US)

(21) Appl. No.: 17/682,497

(22) Filed: Feb. 28, 2022

Related U.S. Application Data
(60) Provisional application No. 63/155,215, filed on Mar. 1, 2021.

(51) Int. Cl. H01Q 3/32; H01Q 9/04

(52) U.S. Cl. CPC H01Q 3/32; H01Q 9/0414

(57) ABSTRACT

A method for designing a phased-array antenna embedded into stacked high impedance surfaces (HIS) structure is proposed. The stacked HIS structure comprises a plurality of HIS cell, which has two plate layers with adjustable height of the lower layer. Each HIS cell has a corresponding LC tank structure. Under a given height (HIS cell volume), the overall capacitance increases when the height of the lower layer plate increases. By adjusting the height of the lower layer plate, a variable capacitance of the corresponding LC tank can be achieved to allow lower operation frequencies of the phased-array antenna and to realize the benefit of HIS in band of interest. In addition, different design conditions can be achieved for the phased-array antenna.

### CROSS REFERENCE TO RELATED APPLICATIONS

This application claims priority under 35 U.S.C. § 119 from U.S. Provisional Application No. 63/155,215, entitled “Low-Profile Low-Cost Phased-Array Antenna-In-Package,” filed on Mar. 1, 2021, the subject matter of which is incorporated herein by reference.

### TECHNICAL FIELD

The disclosed embodiments relate generally to phased-array antenna, and, more particularly, to method of low profile and low cost phased-array antenna-in-package (AiP) implementation.

### BACKGROUND

In antenna theory, a phased antenna array usually means an array of antennas that creates a beam of radio waves can be electronically steered to point in different directions, without moving the antennas. Beamforming is technique by which an array of antennas can be steered to transmit radio signals in a specific direction. The phase and amplitude of each signal is added constructively and distructively in such a way that they concentrate the energy into a narrow beam or lobe. For multiple array antennas operate in a high-density area, each array antenna has its own beam to point to specific user (direction). For multiple beam array antenna, each antenna beam points to specific direction. The bandwidth shortage increasingly experienced by mobile carriers has motivated the exploration of the under-utilized Millimeter Wave (mmWave) frequency spectrum around 24G and 300G Hz for the next generation 5G broadband cellular communication networks. To support directional communications with narrow beams in mmWave networks, a 5G base station supports multiple beam with phased-array antennas.

Antenna in Package (AiP) is when antennas are integrated into a package along with a Radio Frequency Integrated Circuit (RFIC). In this case, the antennas are no longer a separate component placed within the wireless device, but they are directly integrated into the package along with other ICs. AiP technology can reduce the size of a wireless system significantly. Also, since the antenna in an AiP solution is closer to the RFIC, the transmission losses are lower, which helps to improve the transmitter efficiency and the receiver noise figure. In addition, the AiP solution reduces system and assembly cost and time to market. AiP technology is now widely adopted by chipmakers for high-frequency applications as the antenna size can be small enough to fit into a small package. As a result, it is used in 60 GHz radios, gesture radars, 79 GHz automotive radars, 94 GHz phased arrays, 122 GHz, 145 GHz, and 160 GHz sensors, as well as 300 GHz wireless links.

Microstrip antennas are extensively used because of their small size, light weight, easy processing and easy integration in circuits. There are many challenges in implementing microstrip patch antennas, including narrowband, e.g., typically <3% fractional bandwidth. Conventional solutions have been applied to increase bandwidth, however, at the cost of increased dielectric thickness, increased size of antenna, and decreased gain, etc. High-Impedance Surfaces (HIS) are periodic cells such that the surface impedance is very high across a frequency band. The high-impedance ground plane is a metal sheet with a two-dimensional periodic resonant texture that suppresses surface wave in a desired frequency range called the bandgap. In this bandgap, the resonance results in a suppression of surface waves by the high-impedance ground plane that is beneficial in antenna applications, including 1) increase gain, bandwidth, and front-to-back ratio of antennas; 2) inhibit surface waves, reducing inter-element coupling in antenna arrays and blind spots in radiation pattern. The design of HIS antenna, however, is complex as it consists of a metallic electromagnetic structure with high surface impedance.

### SUMMARY

A method for designing a phased-array antenna embedded into stacked high impedance surfaces (HIS) structure is proposed. The stacked HIS structure comprises a plurality of HIS cell, which has two plate layers with adjustable height of the lower layer. Each HIS cell has a corresponding LC tank structure. Under a given height (HIS cell volume), the overall capacitance increases when the height of the lower layer plate increases. By adjusting the height of the lower layer plate, a variable capacitance of the corresponding LC tank can be achieved to allow lower operation frequencies of the phased-array antenna and to realize the benefit of HIS in band of interest. In addition, different design conditions can be achieved for the phased-array antenna.

In one embodiment, a phased-array antenna receives an input signal. The phased-array antenna has a plurality of antenna elements formed on a substrate. The plurality of antenna elements has a first periodicity, and the first periodicity is less than half of a wavelength of the input signal. The phased-array antenna processes the input signal. The phased-array antenna is embedded into a high-impedance surface (HIS) structure. The HIS structure has a ground plane and a plurality of two-dimensional HIS cells formed on the substrate. The plurality of HIS cells has a second periodicity. Each HIS cell comprises 1) a first plate formed over and coupled to the ground plane, the first plate having a first height to the ground plane; and 2) a second plate stacked over and coupled to the first plate, the second plate having a second height to the ground plane. The HIS structure has a high impedance across a band of interest by achieving a list of predefined conditions and by adjusting the first height.

Other embodiments and advantages are described in the detailed description below. This summary does not purport to define the invention. The invention is defined by the claims.

### BRIEF DESCRIPTION OF THE DRAWINGS

FIG. 1 illustrates a top-down view of an Antenna in Package (AiP) and a side view of a stacked High-Impedance Surfaces (HIS) structure in accordance with one novel aspect.

FIG. 2 illustrates a top-down view of High-Impedance Surfaces (HIS) that can be used for implementing phased array antennas.

FIG. 3 illustrates a side view of High-Impedance Surfaces (HIS) and equivalent LC tank structure between individual HIS cells.

FIG. 4 illustrates steps for achieving conditions in designing phased array antenna with HIS structure in accordance with one novel aspect.

FIG. 5 illustrates a side view of a stacked HIS and equivalent LC tank structure between individual HIS cells in accordance with one novel aspect.

FIG. 6 illustrates a top-down view of one example of patched antenna elements embedded into stacked HIS layers that enclose each antenna element in accordance with one novel aspect.

FIG. 7 is a flow chart of a method for designing a phased-array antenna embedded into stacked HIS layers in accordance with one novel aspect.

### DETAILED DESCRIPTION

Reference will now be made in detail to some embodiments of the invention, examples of which are illustrated in the accompanying drawings.

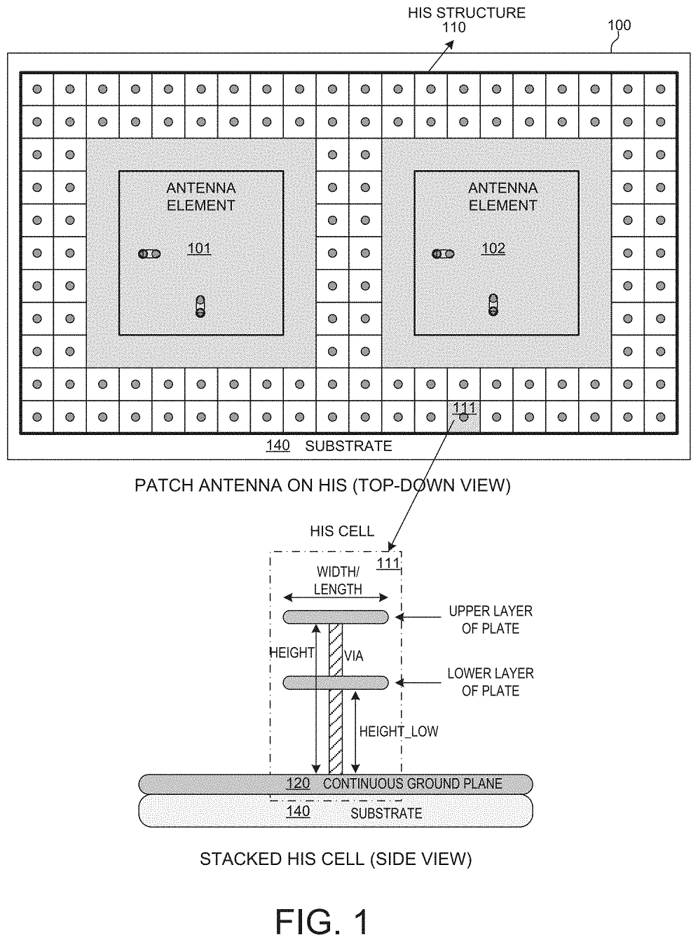

FIG. 1 illustrates a top-down view of an Antenna in Package (AiP) 100 and a side view of a stacked High-Impedance Surfaces (HIS) structure 110 in accordance with one novel aspect. AiP 100 comprises a plurality of antenna elements, including antenna elements 101 and 102, that are formed on a substrate 140 and imbedded into an HIS structure 110. HIS structure 110 comprises a plurality of two-dimensional HIS cells, e.g., HIS cell 111, formed on the same substrate. Each antenna element is surrounded by rows and columns of HIS cells. AiP technology is now widely adopted by chipmakers for high-frequency applications including phased-array antenna, as the antenna size can be small enough to fit into a small package. Microstrip patch antennas are extensively used because of their small size, light weight, easy processing and easy integration in circuits.

AiP 100 is a phased-array microstrip patch antenna, which steers beams electronically without mechanical moving parts to change directions. The phased-array antenna has small form factor, e.g., <500 μm AiP thickness, <=10 μm minimum feature lengths (i.e., layer thickness, line width, metal-to-metal spacing). The phased-array antenna utilizes high impedance surfaces to present a high impedance at the band of interest, to achieve above average gain, and to reduce mutual coupling between antenna array elements and radiation in unintended directions. There are many challenges in implementing microstrip patch antennas, including narrowband, e.g., typically <3% fractional bandwidth. Conventional solutions have been applied to increase bandwidth, however, at the cost of increased dielectric thickness, increased size of antenna, and decreased gain, etc.

In accordance with one novel aspect, a method for designing a phased-array antenna embedded into stacked HIS structure is proposed. In the example of FIG. 1, the stacked HIS structure 110 has two plate layers with adjustable height of the lower layer. As depicted in FIG. 1, the lower plate layer of HIS cell 111 has a “Height_Low”, e.g., the distance from the first plate to the ground plane 120, and the upper plate layer of HIS cell 111 has a “Height”, e.g., the distance from the second plate to the ground plane 120. The upper/second plate layer is stacked over the lower/first plate layer. Under a given “Height” (HIS cell volume), the overall capacitance increases when the height of the lower layer “Height_Low” increases. By adjusting the height of the lower layer plate, a variable capacitance of a corresponding LC circuit can be achieved to allow lower operation frequencies of the phased-array antenna and to realize the benefit of HIS in band of interest, while satisfying various phased-array antenna design conditions.

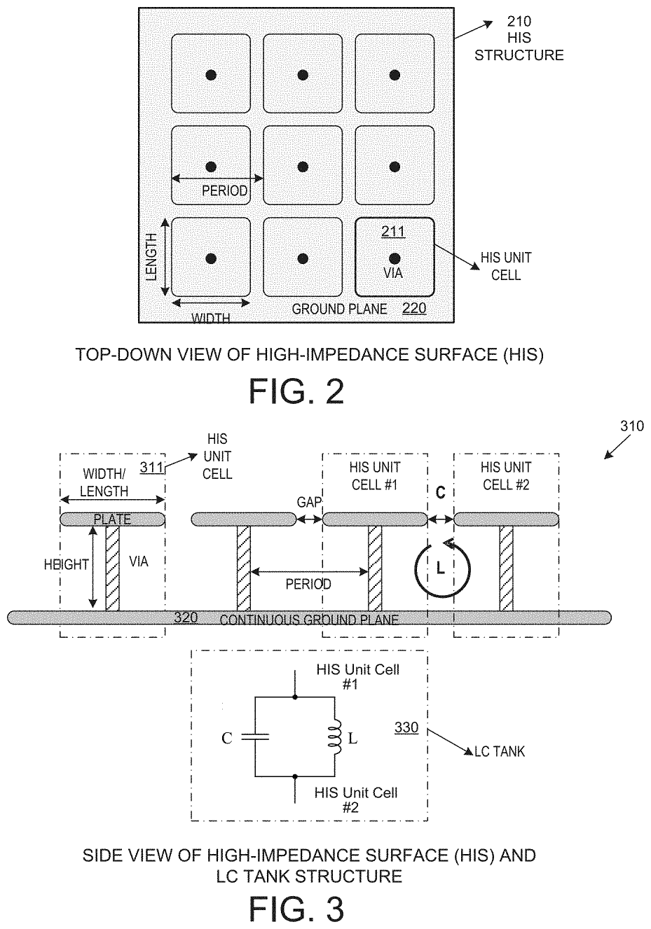

FIG. 2 illustrates a top-down view of High-Impedance Surfaces (HIS) structure 210 that can be used for implementing phased array antennas. High-Impedance Surfaces (HIS) are periodic cells such that the surface impedance is very high across a frequency band. The high-impedance ground plane is a metal sheet with a two-dimensional periodic resonant texture that suppresses surface wave in a desired frequency range called the bandgap. In this bandgap, the resonance results in a suppression of surface waves by the high-impedance ground plane that is beneficial in antenna applications, including 1) increase gain, bandwidth, and front-to-back ratio of antennas; 2) inhibit surface waves, reducing inter-element coupling in antenna arrays and blind spots in radiation pattern.

In the example of FIG. 2, HIS 210 comprises a plurality of two-dimensional HIS unit cells, including HIS cell 211. Each HIS unit cell (e.g., cell 211) has a plate of a length and a width, formed on a high-impedance ground plane 220 and coupled to the ground plane 220 through via. The plate is part of a metallization layer that is patterned to form the two-dimensional periodic array of cells with a periodicity equal to “Period”. By using such an array, the reflection coefficient of the electric field has a zero phase, which causes the HIS to have a high impedance. The design of HIS antenna, however, is complex because it consists of a metallic electromagnetic structure with high surface impedance.

FIG. 3 illustrates a side view of High-Impedance Surfaces (HIS) and equivalent LC tank structure between individual HIS cells. In the example of FIG. 3, HIS 310 comprises a plurality of two-dimensional HIS unit cells, including HIS cell 311. Each HIS unit cell (e.g., cell 311) has a plate of a Length and a Width, formed on a high-impedance ground plane 320 and coupled to the ground plane through via. Horizontally, the HIS cells are periodically formed and having a periodicity of “Period”. Neighboring HIS cells are separated by a distance “Gap”. Vertically, the via of each HIS cell has a “Height”, e.g., the distance from the plate to the ground plane.

The HIS unit cell needs to be designed to have high impedance across band of interest. High impedance is achieved as phase response approaches to 0 degrees, and bandwidth is considered to be where phase response is from −90 degrees to +90 degrees. The HIS structure can be viewed as parallel LC tank structure between individual HIS cells. In resonant region, high impedance prevents surface waves and current flow across HIS. In resonant region, impinging waves are reflected in-phase and reinforce radiating wave. As depicted in FIG. 3, an equivalent parallel LC tank 330 exists between HIS unit cell #1 and HIS unit cell #2. It has been observed that the capacitance C increases when Gap decreases and when the metal thickness of increases. As capacitance C increases, resonant frequency decreases and fractional bandwidth decreases. Similarly, the inductance L increases when the via Height increases, the via diameter decreases, and the Width/Length and Period increases. As inductance L increases, resonant frequency decreases and fractional bandwidth decreases. Typically, in order to lower the resonant frequency, the trade-off is to increase HIS cell size and metal thickness.

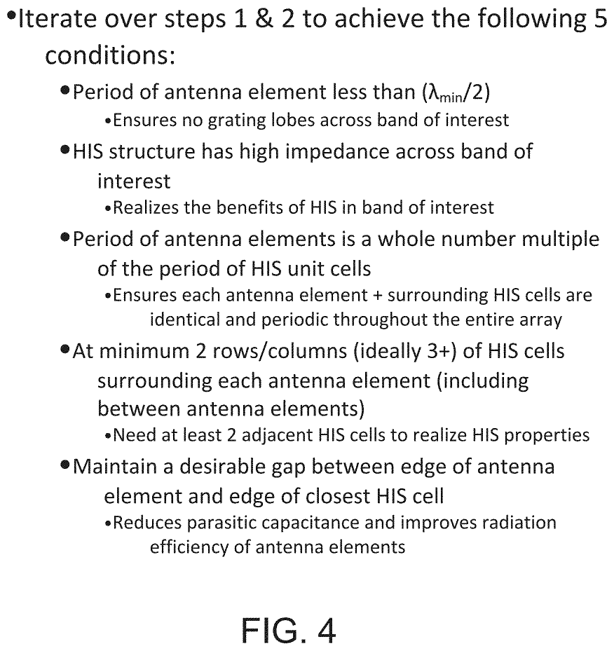

FIG. 4 illustrates steps for achieving conditions in designing phased array antenna with HIS structure in accordance with one novel aspect. For AiP technology, radiation is typically reflected within the package of substrate supporting the antenna, generating surface waves. At the edge of the package or substrate, the surface waves can generate parasitic currents that distort the wave pattern. HIS is thus employed to inhibit surface waves and prevent the parasitic currents that cause the wave pattern distortion. For AiP design utilizing HIS structure, two design steps are involved: 1) determining the period between elements of the antenna array to be less than (Δₘᵢₙ/2) to ensure no grating lobes across band of interest; and 2) designing HIS unit cells to have high impedance across band of interest.

As depicted in FIG. 4, the above steps 1) and 2) are iterated to achieve the following conditions: a) determining the period between elements of the antenna array to be less than (λₘᵢₙ/2) (half of wavelength of input signal)—to ensure no grating lobes across band of interest; b) designing HIS unit cells to have high impedance across band of interest—to realize the benefits of HIS in band of interest; c) determining the period of antenna elements to be a whole number multiple of the period of HIS unit cells—to ensure each antenna element and the surrounding HIS cells are identical and periodic throughout the entire phased-array antenna; d) designing at least two rows/columns (ideally three+rows/columns) of HIS cells surrounding each antenna element (including between neighboring antenna elements)—need at least two adjacent HIS cells to realize HIS properties; and e) maintaining a desirable gap between the edge of antenna element and the edge of the closest HIS cell—to reduce parasitic capacitance and improves radiation efficiency of antenna elements.

For lower operating frequencies or confined design dimensions, however, basic HIS structure is often insufficient to achieve all the above conditions from a) to e). In one example, the conditions (a)-(c) can be fulfilled, but there is insufficient lateral space between antenna elements to achieve (d) and (e). In another example, conditions (a) and (c)-(e) can be fulfilled, but the HIS structure is not resonant in the band of interest or has very thick substrate, nullifying condition (b) and HIS benefits. Accordingly, a stacked HIS structure is introduced for phased-array antenna design. Specifically, the stacked HIS structure has two plate layers with adjustable via heights. By adjusting the via heights, a variable capacitance of the corresponding LC tank can be achieved to allow lower operation frequencies of the phased-array antenna.

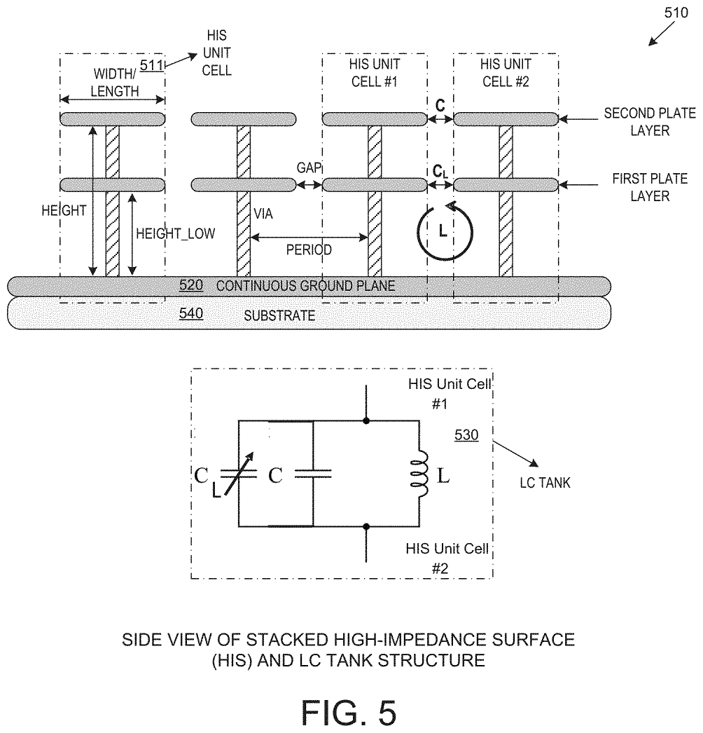

FIG. 5 illustrates a side view of a stacked HIS and equivalent LC tank structure between individual HIS cells in accordance with one novel aspect. In the example of FIG. 5, HIS 510 comprises a plurality of two-dimensional HIS unit cells, including HIS cell 511. Each HIS unit cell (e.g., cell 511) has a first plate layer of a Length and a Width, formed on a high-impedance ground plane 520 and coupled to the ground plane through via, and a second plate layer of Length and a Width, formed on top of the first player layer and also coupled to the ground plane through via. Horizontally, the HIS cells are periodically formed and having a periodicity of “Period”. Neighboring HIS cells are separated by a distance “Gap”. Vertically, the first plate layer of each HIS cell has a “Height_Low”, e.g., the distance from the first plate to the ground plane, and the second plate layer of each HIS cell has a “Height”, e.g., the distance from the second plate to the ground plane. The second plate layer is stacked over the first plate layer.

As illustrated earlier, the HIS unit cell needs to be designed to have high impedance across band of interest. High impedance is achieved as phase response approaches to 0 degrees, and bandwidth is considered to be where phase response is −90 degrees to +90 degrees. The HIS structure can be viewed as parallel LC tank structure between individual HIS cells. It has been observed that the capacitance C increases when Gap decreases and when the metal thickness of increases. As capacitance C increases, resonant frequency decreases and fractional bandwidth decreases. Similarly, the inductance L increases when the via Height increases, the via diameter decreases, and the Width/Length and Period increases. As inductance L increases, resonant frequency decreases and fractional bandwidth decreases. Typically, in order to lower the resonant frequency of HIS, the trade-off is to increase HIS cell size and metal thickness.

In accordance with one novel aspect, a stacked HIS structure is introduced for phased-array antenna design. Specifically, the stacked HIS structure has two plate layers with adjustable via heights. As depicted in FIG. 5, an equivalent parallel LC tank 530 exists between HIS unit cell #1 and HIS unit cell #2. Because there are two plate layers in each HIS cell, there are two parallel capacitors C and C_{L} in the LC circuit 530, where C_{L} corresponds to the first plate, and C corresponds to the second plate. Because there are two parallel capacitors, under a given Height (HIS cell volume), the overall capacitance increases when the Height_Low increases. Thus, effectively, the bottom part of the HIS cell is a variable capacitor as a function of Height_Low. By adjusting Height_Low, a variable capacitance of the corresponding LC tank can be achieved to allow lower operation frequencies of the phased-array antenna. The stacked planar is also easy to manufacture.

Note that the above-illustrated method is not limited to two plates per HIS cell. Technically, the stacked HIS structure can be expanded to “n>=2” plates stacked vertically per HIS cell, which would give the designing of a phased-array antenna additional degrees of freedom. Further, the plates of different HIS unit cells do not necessarily have to be at the same height. This method can work on stacked HIS cells where the plates are interleaved, even though the drawing in FIG. 5 shows only plates which are at the same heights.

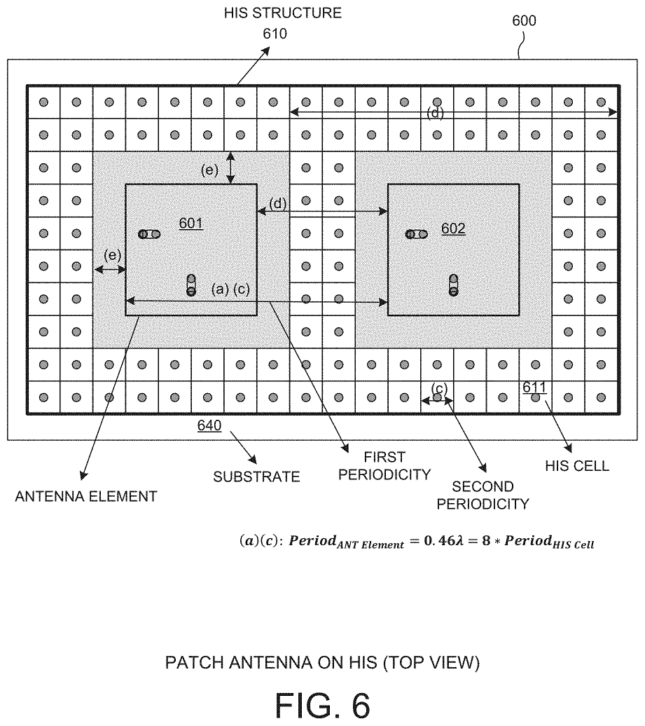

FIG. 6 illustrates a top-down view of one example of an AiP 600 with patched antenna elements embedded into stacked HIS layers that enclose each antenna element in accordance with one novel aspect. AiP 600 is a phased-array microstrip patch antenna, which steers beams electronically without mechanical moving parts to change directions. The phased-array antenna has small form factor, e.g., <500 μm AiP thickness, <=10 μm minimum feature lengths (i.e., layer thickness, line width, metal-to-metal spacing). The phased-array antenna utilizes high impedance surfaces to present a high impedance at the band of interest, to achieve above average gain, and to reduce mutual coupling between antenna array elements and radiation in unintended directions.

AiP 600 comprises a plurality of antenna elements, including antenna elements 601 and 602, that are formed on a substrate 640 and imbedded into an HIS structure 610. HIS structure 610 comprises a plurality of two-dimensional HIS cells, e.g., HIS cell 611, formed on the same substrate. Each antenna element is surrounded by rows and columns of HIS cells. As illustrated earlier with respect to FIG. 4, for AiP technology, HIS is employed to inhibit surface waves and prevent the parasitic currents that cause the wave pattern distortion. For AiP design utilizing HIS structure, two design steps are involved: 1) determining the period between elements of the antenna array to be less than (λₘᵢₙ/2) to ensure no grating lobes across band of interest; and 2) designing HIS unit cells to have high impedance across band of interest.

In FIG. 6, the HIS structure 610 is a stacked HIS structure, e.g., having two stacked plate layers with adjustable via Heights, similar to the stacked HIS structure 510 depicted in FIG. 5. The stacked HIS structure can facilitate the AiP design process, e.g., steps 1) and 2) are iterated to achieve the following conditions: a) determining the period between elements of the antenna array to be less than (λₘᵢₙ/2); b) designing HIS unit cells to have high impedance across band of interest; c) determining the period of antenna elements to be a whole number multiple of the period of HIS unit cells; d) designing at least two rows/columns of HIS cells surrounding each antenna element; and e) maintaining a desirable gap between the edge of antenna element and the edge of the closest HIS cell.

In the example of FIG. 6, the conditions and related design parameters are depicted for further illustration. For example, condition a) related to the “first periodicity”—the periodicity of antenna elements Period_{ANT Element}, and condition c) is related to both the Period_{ANT Element} and the “second periodicity”—the periodicity of HIS cells Period_{HIS cell}. To achieve condition a), the first periodicity Period_{ANT Element}=0.46λ<=half of the minimum wavelength (λₘᵢₙ/2) of input signal. To achieve condition c), the first periodicity Period_{ANT Element}=8*the second periodicity Period_{HIS cell}. Condition d) is related to the size of antenna elements and the distance between antenna elements. In FIG. 6, each antenna element is surrounded by two HIS rows/columns, although ideally three HIS rows/columns are preferred. Condition e) is related to the minimum distance between each antenna element and a neighboring HIS cell. In FIG. 6, the gap between the edge of antenna element and the closest HIS cell is equal to HIS cell periodicity.

Basic HIS structure is often insufficient to achieve all the above conditions from a) to e), especially for lower operating frequencies or confined design dimensions of phased-array antenna. In order to lower the resonant frequency of HIS, typically, the trade-off is to increase HIS cell size and metal thickness. Accordingly, the stacked HIS structure 610 is used for designing and implementing AiP 600 in FIG. 6. Specifically, the stacked HIS structure has two plate layers with adjustable height of the lower layer. Because there are two parallel capacitors in the equivalent LC circuit, under a given height (HIS cell volume), the overall capacitance increases when the height of the lower layer increases. By adjusting the height of the lower layer plate, a variable capacitance of the corresponding LC circuit can be achieved to allow lower operation frequencies of the phased-array antenna and realize the benefit of HIS in band of interest, as well as to achieve all the conditions from (a) to (e) of the phased-array antenna design.

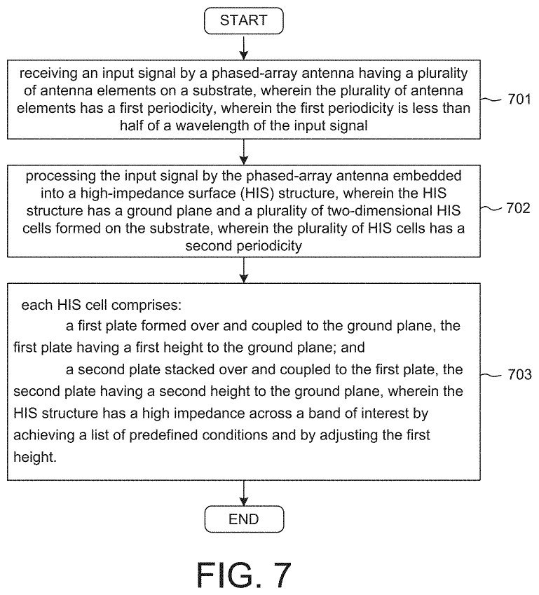

FIG. 7 is a flow chart of a method for designing a phased-array antenna embedded into stacked HIS layers in accordance with one novel aspect. In step 701, a phased-array antenna receives an input signal. The phased-array antenna has a plurality of antenna elements formed on a substrate. The plurality of antenna elements has a first periodicity, and the first periodicity is less than half of a wavelength of the input signal. In step 702, the phased-array antenna processes the input signal. The phased-array antenna is embedded into a high-impedance surface (HIS) structure. The HIS structure has a ground plane and a plurality of two-dimensional HIS cells formed on the substrate. The plurality of HIS cells has a second periodicity. Each HIS cell comprises 1) a first plate formed over and coupled to the ground plane, the first plate having a first height to the ground plane; and 2) a second plate stacked over and coupled to the first plate, the second plate having a second height to the ground plane. The HIS structure has a high impedance across a band of interest by achieving a list of predefined conditions and by adjusting the first height.

In one embodiment, to use the HIS structure as specified, exceptionally fine feature dimensions down to 10 um or less are often required—especially if thin form factor is desired. In one example, the metal layer is down to 6 μm thick, and the dielectric layer is down to 7 μm thick. A small form-factor mmWave Phased-Array Antenna-in-Package can be designed as follows: for 5G mobile handsets, 19.5 mm×6.65 mm×0.5 mm (L×W×H), 26.5 GHz to 29.5 GHz (n257 band), +/−60 degrees scan range, and mmWave IC flip-chip mounted on the back of the AiP.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method, comprising:
receiving an input signal by a phased-array antenna having a plurality of antenna elements formed on a substrate, wherein the plurality of antenna elements has a first periodicity, wherein the first periodicity is less than half of a wavelength of the input signal; and
processing the input signal by the phased-array antenna embedded into a high-impedance surface (HIS) structure, wherein the HIS structure has a ground plane and a plurality of two-dimensional HIS cells formed on the substrate, wherein the plurality of HIS cells has a second periodicity, and wherein each HIS cell comprises:
a first plate formed over and coupled to the ground plane, the first plate having a first height to the ground plane; and
a second plate stacked over and coupled to the first plate, the second plate having a second height to the ground plane, wherein the HIS structure has a high impedance across a band of interest by achieving a list of predefined conditions and by adjusting the first height.

2. The method of claim 1, wherein the first periodicity is an integer number multiple of the second periodicity.

3. The method of claim 2, wherein each antenna element and surrounding HIS cells have identical pattern throughout the phased array antenna.

4. The method of claim 1, wherein each antenna element is surrounded by a minimum of two rows or two columns of the plurality of two-dimensional HIS cells.

5. The AiP of claim 4, wherein at least two adjacent HIS cells are required to realize HIS properties.

6. The AiP of claim 1, wherein an edge of each antenna element and an edge of a closest HIS cell is separated by a minimum gap.

7. The AiP of claim 6, wherein the minimum gap reduces parasitic capacitance and improves radiation efficiency of each antenna element.

8. The AiP of claim 1, wherein the HIS structure presents parallel resonant L-C tank circuits between individual HIS cells.

9. The AiP of claim 8, wherein the first plate and the second plate form a stacked HIS cell having a capacitance that is a function of the first height and the second height.

10. The AiP of claim 9, wherein the capacitance increases when the first height increases while the second height remains same.

11. A phased-array antenna, comprising:
a plurality of antenna elements formed on a substrate, wherein the plurality of antenna elements has a first periodicity, wherein the first periodicity is less than half of a wavelength of an input signal; and
a high-impedance surface (HIS) structure having a ground plane and a plurality of two-dimensional HIS cells formed on the substrate, wherein the phased array antenna is embedded into the HIS structure, wherein the plurality of HIS cells has a second periodicity, and wherein each HIS cell comprises:
a first plate formed over and coupled to the ground plane, the first plate having a first height to the ground plane; and
a second plate stacked over and coupled to the first plate, the second plate having a second height to the ground plane, wherein the HIS structure has a high impedance across a band of interest by achieving a list of predefined conditions and by adjusting the first height.

12. The antenna of claim 11, wherein the first periodicity is an integer number multiple of the second periodicity.

13. The antenna of claim 12, wherein each antenna element and surrounding HIS cells have identical pattern throughout the phased array antenna.

14. The antenna of claim 11, wherein each antenna element is surrounded by a minimum of two rows or two columns of the plurality of two-dimensional HIS cells.

15. The antenna of claim 14, wherein at least two adjacent HIS cells are required to realize HIS properties.

16. The antenna of claim 11, wherein an edge of each antenna element and an edge of a closest HIS cell is separated by a minimum gap.

17. The antenna of claim 16, wherein the minimum gap reduces parasitic capacitance and improves radiation efficiency of each antenna element.

18. The antenna of claim 11, wherein the HIS structure presents parallel resonant L-C tank circuits between individual HIS cells.

19. The antenna of claim 18, wherein the first plate and the second plate form a stacked HIS cell having a capacitance that is a function of the first height and the second height.

20. The antenna of claim 19, wherein the capacitance increases when the first height increases while the second height remains same.
